(19) United States
(12) Patent Application Publication
(10) Pub. No.: US 2014/0321158 A1
(43) Pub. Date: Oct. 30, 2014

(54) LIGHT SOURCE MODULE

(71) Applicant: HON HAI PRECISION INDUSTRY CO., LTD., New Taipei (TW)

(72) Inventor: PO-CHOU CHEN, Tu-Cheng (TW)

(73) Assignee: HON HAI PRECISION INDUSTRY CO., LTD., New Taipei (TW)

(21) Appl. No.: 14/257,008

(22) Filed: Apr. 21, 2014

(30) Foreign Application Priority Data
Apr. 30, 2013 (TW) 102115354

(51) Int. Cl. F21V 8/00

(52) U.S. Cl. CPC G02B 6/0031; G02B 6/003
USPC 362/609

(57) ABSTRACT

A light source module with a wide angle of illumination into a light guide plate includes a light source unit and a light guide plate. The light source unit includes a laser light source, a light converging member, and a reflective member. The laser light source emits a synthesized white laser beams. The light converging member converges the synthesized white laser beams onto the reflective member. The reflective member faces a light incident surface of the the light guide plate and spreads the reflected light out in a wider angle towards the light incident surface. Light is emitted from all parts of the light guide plate out through the light output surface.

### FIELD

The present disclosure relates to a light source module.

### BACKGROUND

In a light source module, a light emitting diode (LED) emitting white light is placed in front of a corner of a light guide plate. The light guide plate is used to disperse the white light towards a light output surface. However, due to the continuous spectrum of the white light from the LED, the light source module has a narrow angle of emission and a narrow color range.

Therefore, it is desirable to provide a light source module overcoming or at least alleviating the above-mentioned problems.

### BRIEF DESCRIPTION OF THE DRAWINGS

FIG. 1 is a schematic view of an embodiment of a light source module including a laser light source and a light guide plate.

FIG. 2 is a schematic view of the laser light source of FIG. 1.

FIG. 3 is a schematic, isometric view of the light guide plate of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

Embodiments of the disclosure will be described with reference to the accompanying drawings.

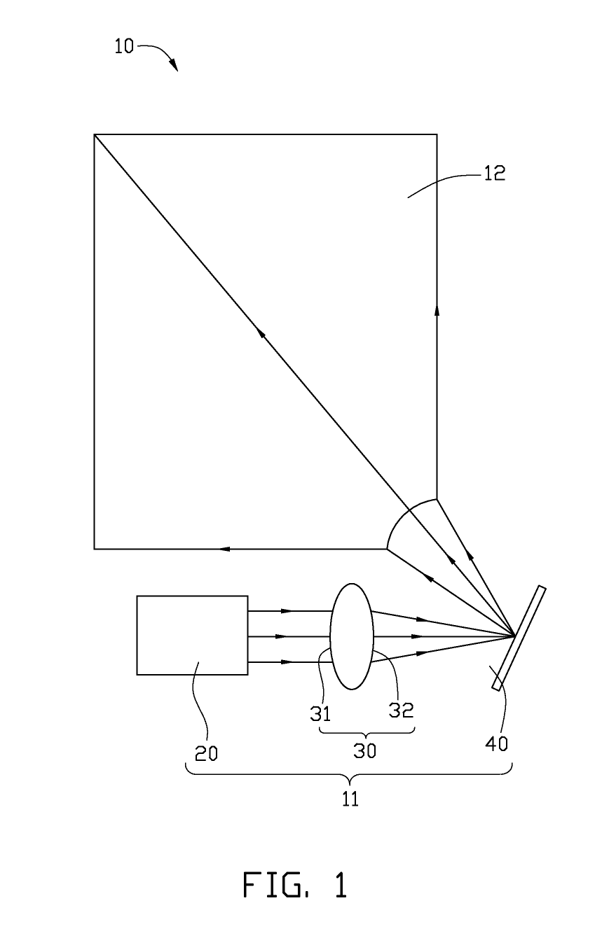

FIG. 1 illustrates an embodiment of a light source module 10. The light source module 10 includes a light source unit 11 and a light guide plate 12. The light source unit 11 includes a laser light source 20, a light converging member 30, and a reflection member 40.

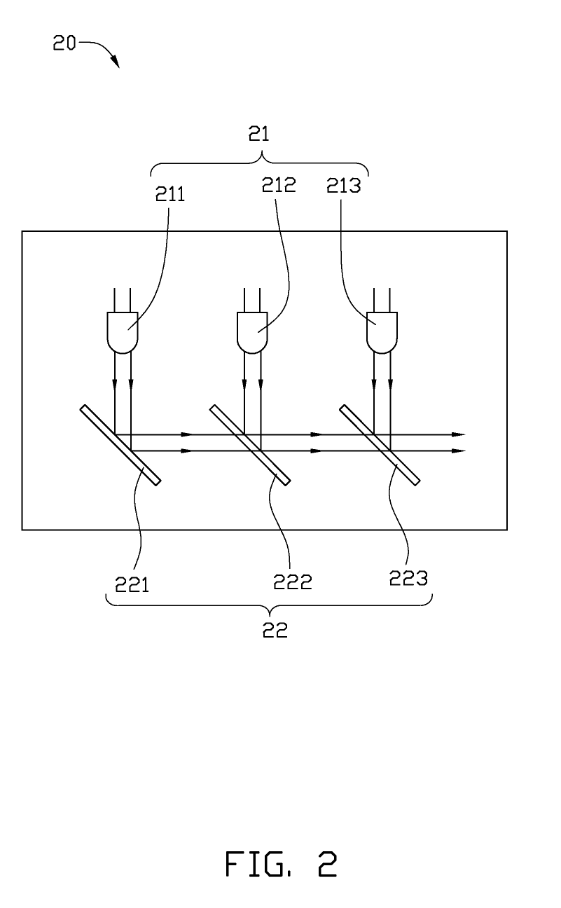

FIG. 2 illustrates the laser light source 20 including a plurality of light source elements 21 and a plurality of reflection elements 22. The laser light source 20 includes a first light source element 211, a second light source element 212, a third light source element 213, a first reflection element 221, a second reflection element 222, and a third reflection element 223.

The first, second, and third light source elements 211, 212, and 213 can be laser diodes. The three light source elements 211, 212, and 213 are configured to emit red, green, and blue laser beams. In one embodiment, the first light source element 211 is configured to emit red laser beams, the second light source element 212 is configured to emit green laser beams, and the third light source element 213 is configured to emit blue laser beams.

The first, second, and third reflection elements 221, 222, and 223 are substantially parallel to each other, and located reflecting the light output directions of the first, second, and third light source elements 211, 212, and 213 respectively. Each of the three reflection elements 221, 222, and 223 is configured to reflect one of a red light, of a green light, and of a blue light, and allow the other two colored lights to pass through. In one embodiment, the first reflection element 221 is configured to reflect red light emitted from the first light source element 211. The red light reflected by the first reflection element 221 then penetrates the second reflection element 222 and the third reflection element 223 towards the light converging member 30. The second reflection element 222 is configured to reflect green light emitted from the second light source element 212. The green light reflected by the second reflection element 222 then penetrates the third reflection element 223 towards the light converging member 30. The third reflection element 223 is configured to reflect blue light emitted from the third light source element 213 towards the light converging member 30. The red light, green light, and blue light are synthesized to form a synthesized white laser beam.

FIG. 1 illustrates the light converging member 30 located between the laser light source 20 and the reflection member 40.

In this embodiment, the light converging element 30 is a converging lens, such as a convex lens, a Fresnel lens, or a compound parabolic concentrator (CPC). The light converging element 30 receives the synthesized white laser beams emitted from the laser light source 20. The light converging member 30 includes a light incident side 31 and a light output side 32. The synthesized white laser beam enters the light converging member 30 through the light incident side 31 and is emitted out of the light converging member 30 through the light output side 32 to reach the reflection member 40.

FIG. 1 illustrates the reflection member 40 located at the light output side 32 of the light converging member 30. The reflection member 40 is configured to reflect the converged white laser beam from the light converging element 30 towards the light guide plate 12.

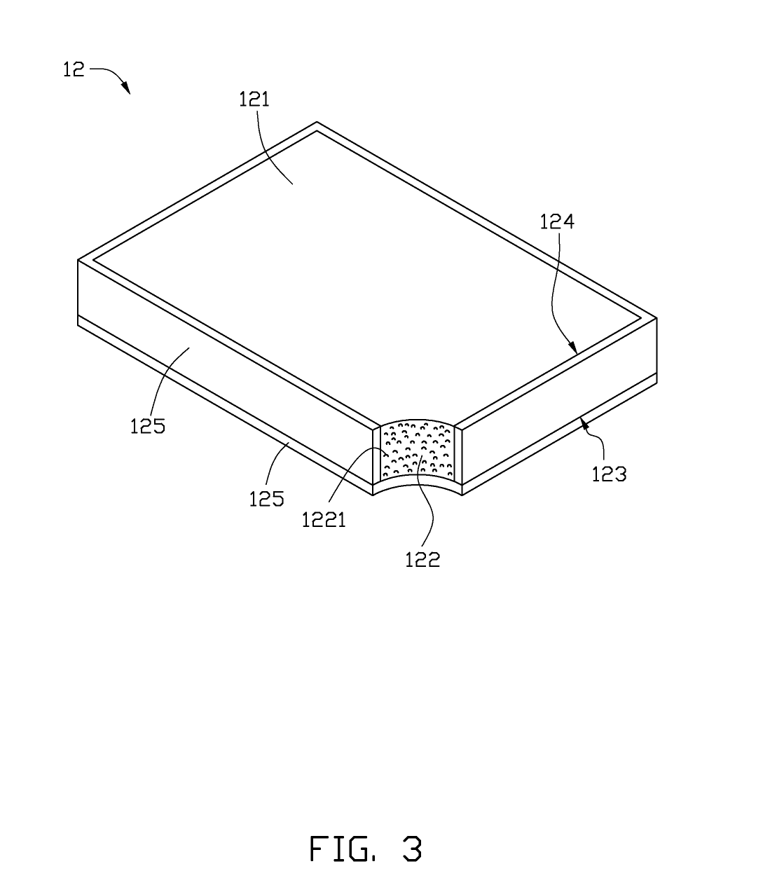

FIG. 3 illustrates the light guide plate 12. The light guide plate 12 is substantially rectangular. The light guide plate 12 is made of transparent material, such as Polymethyl Methacrylate (PMMA), Polycarbonate (PC), silicone, or glass. The light guide plate 12 includes a light output surface 121, a light incident surface 122, a bottom surface 123, and four side surfaces 124. The four side surfaces 124 and the light incident surface 122 are connected to each other. The bottom surface 123 and the light output surface 121 are opposite to and substantially parallel to each other. The four side surfaces 124 and the light incident surface 122 are interconnected between the light output surface 121 and the bottom surface 123. The light incident surface 122 is curved and connects adjacent side surfaces 124. The light incident surface 122 is recessed into the light guide plate 12 and faces the reflection member 40. In this embodiment, the bottom surface 123 and the four side surfaces 124 are covered by reflecting films 125. A number of microstructures 1221 are formed on the light incident surface 122.

During operation of the light source module 10, the synthesized white laser beam is converged by the converging member 30 into the reflection member 40, reflected by the reflection member 40 towards the light incident surface 122, enters the light guide plate 12 through the light incident surface 122, and emitted out of the light guide plate 12 through the light output surface 121.

Even though numerous characteristics and advantages of the present embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A light source module comprising:
a light source unit comprising a laser light source, a light converging member, and a reflection member; and
a light guide plate comprising a light incident surface, wherein the laser light source emits synthesized white laser beams, the light converging member is located between the laser light source and the reflection member, the light converging member converges the synthesized white laser beams towards the reflection member, and the reflection member reflects the synthesized white laser beams towards the light incident surface.

2. The light source module of claim 1, wherein the laser light source comprises a first light source element, a second light source element, a third light source element, a first reflection element, a second reflection element, and a third reflection element, the first, second, and third light source elements are configured to emit red, green, and blue laser beams respectively, the first, second, and third reflection elements are configured to reflect red, green, and blue laser beams respectively, and the red, green, and blue laser beams are synthesized to form the synthesized white laser beams.

3. The light source module of claim 2, wherein the first, second, and third reflection elements are substantially parallel to each other, and each of the first, second, and third reflection elements reflects one of red light, green light, and blue light and allows the other two colors of light to penetrate through.

4. The light source module of claim 1, wherein the light converging element is a converging lens.

5. The light source module of claim 1, wherein the light guide plate further comprises a light output surface, a bottom surface and four side surfaces, the bottom surface and the light output surface are opposite to and substantially parallel to each other, and the four side surfaces and the light incident surface connect to each other end-to-end and are interconnected between the light output surface and the bottom surface.

6. The light source module of claim 5, wherein the light incident surface is connected between two adjacent side surfaces.

7. The light source module of claim 6, wherein the light incident surface is a curved surface.

8. The light source module of claim 7, wherein the light incident surface recesses into the light guide plate.

9. The light source module of claim 5, wherein the four side surfaces and the bottom surface are covered by reflecting films.

10. The light source module of claim 1, wherein a number of microstructures are formed on the light incident surface.
